(19) United States
(12) Patent Application Publication
(10) Pub. No.: US 2010/0078582 A1
(43) Pub. Date: Apr. 1, 2010

(54) BEAM IRRADIATION DEVICE AND POSITION SENSING DEVICE

(75) Inventors: Yoshiaki Maeno, Mizuho-Shi (JP); Atsushi Yamaguchi, Ibi-Gun (JP)

Correspondence Address: DITTHAVONG MORI & STEINER, P.C., 918 Prince Street, Alexandria, VA, 22314, US

(73) Assignees: SANYO Electric Co., Ltd, Moriguchi-shi (JP); SANYO Optec Design Co., Ltd, Bunkyo-ku (JP)

(21) Appl. No.: 12/558,181

(22) Filed: Sep. 11, 2009

(30) Foreign Application Priority Data
Sep. 29, 2008 (JP) 2008-251171

(51) Int. Cl. H01J 40/00

(52) U.S. Cl. 250/578.1

(57) ABSTRACT

A beam irradiation device includes an actuator that scans a target region with laser light in a two-dimensional direction, and a servo optical system that changes a traveling direction of servo light along with driving of the actuator. The servo optical system includes a splitting element that splits the servo light, a first position sensing device that receives a first beam split by the splitting element and outputs a signal at a light-receiving position in a first direction, and a second position sensing device that receives a second beam split by the splitting element and outputs a signal at a light-receiving position in a second direction different from the first direction.

This application claims priority under 35 U.S.C. Section 119 of Japanese Patent Application No. 2008-251171 filed Sep. 29, 2008, entitled “BEAM IRRADIATION DEVICE AND POSITION SENSING DEVICE”. The disclosers of the above applications are incorporated herein by reference.

### BACKGROUND OF THE INVENTION

1. Field of the Invention

The present invention relates to a beam irradiation device that irradiates a target region with laser light, more specifically to a beam irradiation device mounted on a laser radar. In addition, the present invention also relates to a position sensing device that uses servo light to optically detect a movement position of a movable part.

2. Disclosure of the Related Art

In recent years, household automobiles and others have been equipped with a laser radar that radiates a laser beam forward in the direction of driving and detects the presence or absence of an obstacle and a distance to the obstacle in a target region from the state of reflected light, for enhancement of driving safety. In general, a laser radar scans a target region with laser light and detects the presence or absence of an obstacle in each scan position, based on the presence or absence of reflected light in each scan position. Further, the laser radar also detects a distance to the obstacle in each scan position in accordance with an amount of time required between the instant of radiation of laser light and the instant of reception of reflected light.

To raise detection accuracy of a laser radar, it is necessary to properly scan a target region with laser light and detect laser light scan positions. Conventionally known laser light scan mechanisms include a scan mechanism using a polygon mirror and a scan mechanism of lens-driven type in which a scan lens is two-dimensionally driven. In addition, a scan mechanism of mirror-rotating type is also known in which a mirror is used to perform laser light scan.

In such a scan mechanism of mirror-rotating type, a mirror is supported so as to be capable of being biaxially driven, and is rotated around the drive axes by an electromagnetic force between a coil and a magnet. Laser light is entered diagonally into the mirror, and the mirror is biaxially driven around the drive axes, whereby the laser light reflected from the mirror scans a target region in a two-dimensional direction.

In this scan mechanism, laser light scan positions in the target region correspond to mirror rotational positions on a one-to-one basis. Therefore, laser light scan positions can be detected by detecting mirror rotational positions. In such an arrangement, a rotational position of the mirror can be detected by detecting a rotational position of another member which rotates with the mirror, for example.

FIG. 10A is a diagram showing an example of an arrangement for detecting a rotational position of another member as stated above. Reference numeral 601 denotes a semiconductor laser; 602 a transparent body; and 603 a position sensing device (PSD). Laser light emitted from the semiconductor laser 601 is refracted by the transparent body 602 positioned obliquely with respect to a laser light axis, and then is received by the position sensing device 603. At the time, when the transparent body 602 rotates as shown by an arrow in the diagram, a path of the laser light is shifted as shown by a dotted line in FIG. 10A, and a receiving position of laser light on the position sensing detector 603 is changed accordingly. Therefore, it is possible to detect a rotational position of the transparent body 602 using the receiving position of laser light detected by the position sensing device 603.

FIG. 10B is a diagram showing a constitution of the PSD 603 capable of two-dimensional position sensing.

After the path of the laser light has been shifted as stated above by rotation of the transparent body 602, the laser light enters a resistive layer of the PSD 603. Formed on the resistive layer are electrodes X1, X2 for outputting photocurrent in an X-axis direction and electrodes Y1, Y2 for outputting photocurrent in a Y-axis direction (not shown). An incident position of the laser light in the X-axis direction is detected by currents output from the electrodes X1, X2, and an incident position of the laser beam in the Y-axis direction is detected by currents output from the electrodes Y1, Y2. Further, the rotational position of the mirror is detected on the basis of those detection results.

FIG. 10C is a graph showing relationships between current values Ix1, Ix2 output from the electrodes X1, X2 and laser light incident positions. A horizontal axis in FIG. 10C indicates positions between the electrodes X1 and X2.

Since the currents output from the electrodes X1, X2 are inversely proportional to distances between the incident positions and the electrodes as shown in the graph of FIG. 10C, the incident position of the laser light on the light-receiving surface in the X-axis direction can be detected on the basis of the current values Ix1, Ix2 output from the electrodes X1, X2. In addition, the incident position in the Y-axis direction (not shown in the graph) can also be detected in a similar manner, on the basis of current values Iy1, Iy2 output from the electrodes Y1, Y2.

With thus structured PSD 603, it is possible to detect the rotational position of the transparent body 602 in one PSD.

However, when an amount of light received becomes large to some extent, the PSD is saturated with currents output from the electrodes, which deteriorates a linear relationship between light-receiving positions and output current values as shown in FIG. 10D. Specifically, when the output current values exceed a saturation current value in the PSD, relationships between the light-receiving positions and the output current values becomes distorted as shown in FIG. 10D. This makes it extremely difficult to detect properly the light incident position on the PSD, based on the output current values. Therefore, if using the PSD, it is required to control an amount of light received such that output current values do not exceed the saturation current value.

Meanwhile, a two-dimensional PSD has generally different saturation current values in the X-axis and Y-axis directions. Therefore, for correct detection of the light incident position, it is necessary to adjust an amount of light received in accordance with an axis with a smaller saturation current value. However, such saturation current values in the two-dimensional PSD in the axial directions are relatively small, and if an amount of light received is adjusted in accordance with the axis with a smaller saturation current value, a range of light received becomes significantly limited. When a range of an amount of light received is small as stated above, noise influence of ambient light not to be detected is increased, resulting in lowered detection accuracy.

### SUMMARY OF THE INVENTION

A first aspect of the present invention relates to a beam irradiation device. The beam irradiation device in the first aspect includes an actuator that scans a target region with laser light in a two-dimensional direction, and a servo optical system that changes a traveling direction of servo light along with driving of the actuator. In this arrangement, the servo optical system includes a splitting element that splits the servo light, a first position sensing device that receives a first beam split by the splitting element and outputs a signal in accordance with a light-receiving position in a first direction, and a second position sensing device that receives a second beam split by the splitting element and outputs a signal in accordance with a light-receiving position in a second direction different from the first direction.

A second aspect of the present invention relates to a position sensing device that changes a traveling direction of servo light along with movement of a movable part, thereby to detect a movement position of the movable part. The position sensing device in the second aspect includes a splitting element that splits the servo light, a first position sensing device that receives a first beam split by the splitting element and outputs a signal in accordance with a light-receiving position in a first direction, and a second position sensing device that receives a second beam split by the splitting element and outputs a signal in accordance with a light-receiving position in a second direction different from the first direction.

### BRIEF DESCRIPTION OF THE DRAWINGS

The foregoing and other objects and novel features of the present invention will be more fully understood from the following description of the preferred embodiments when reference is made to the accompanying drawings.

FIGS. 1A and 1B are diagrams showing a constitution of a mirror actuator in an embodiment of the present invention;

FIG. 2 is a diagram showing an optical system of a beam irradiation device in the embodiment;

FIGS. 3A and 3B are diagrams showing a servo optical system in the beam irradiation device in the embodiment;

FIGS. 4A to 4D are diagrams showing a constitution of a PSD in the embodiment;

FIGS. 5A to 5D are diagrams describing a method for generating a position sensing signal in the embodiment;

FIG. 6 is a diagram showing a constitution of a position sensing circuit in the embodiment;

FIGS. 7A to 7D are diagrams showing modification examples of a servo light splitting means in the embodiment;

FIGS. 8A to 8C are diagrams describing angle calculations in a modification example of the servo beam splitting means;

FIG. 9 is a diagram showing a modification example of the servo optical system in the embodiment; and

FIGS. 10A to 10D are diagrams describing a method for position sensing using a PSD.

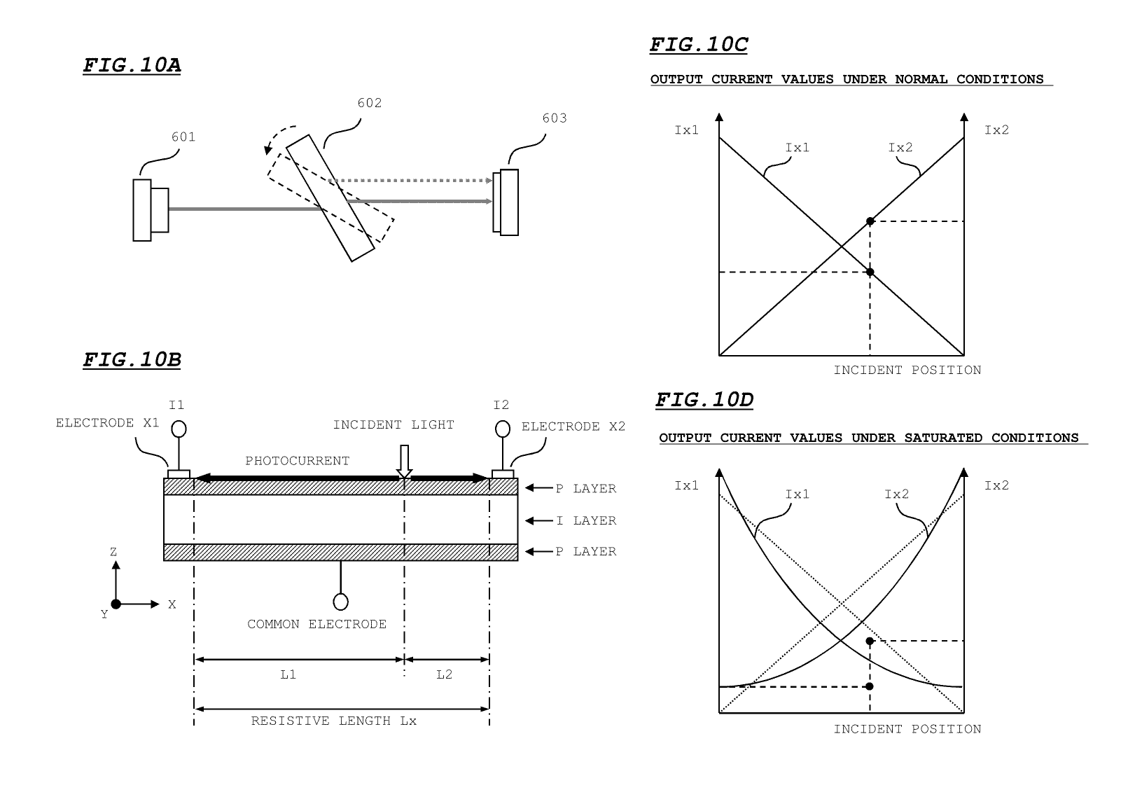

However, the drawings are intended for description only, and do not limit the scope of the present invention.

### DESCRIPTION OF PREFERRED EMBODIMENTS

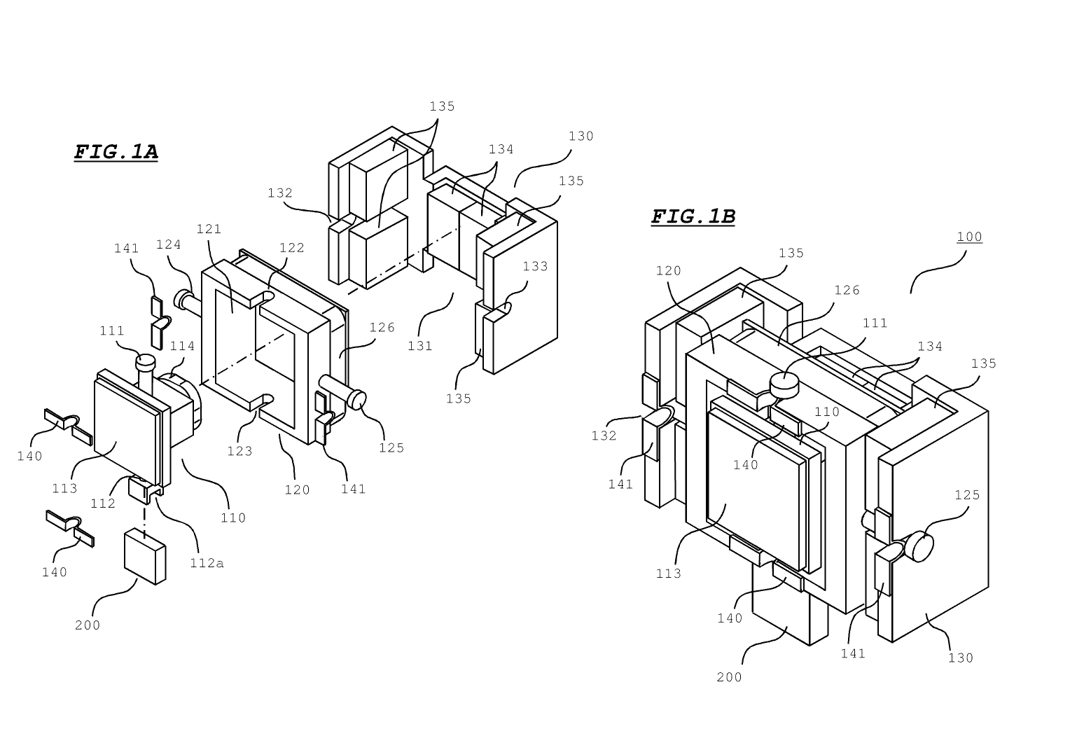

FIGS. 1A and 1B show a constitution of a mirror actuator 100 in an embodiment of the present invention: FIG. 1A is an exploded perspective view of the mirror actuator 100; and FIG. 1B is a perspective view of the assembled mirror actuator 100. In FIG. 1A, reference numeral 110 denotes a mirror holder. The mirror holder 110 has a support shaft 111 with a stopper at an end thereof and a support shaft 112 with a receiver 112a at an end thereof. The receiver 112a is provided with a concave of almost the same dimension as a thickness of a transparent body 200, and the transparent body 200 is fitted at an upper side into the concave. In addition, a flat-plate mirror 113 is placed on a front side of the mirror holder 110, and a coil 114 is placed on a rear side of the same. The coil 114 is wound in a square form.

The parallel plate transparent body 200 is attached to the support shaft 112 with the receiver 112a therebetween, as described above. In this arrangement, the transparent body 200 is attached to the support shaft 112 such that two planes thereof are parallel to a mirror surface of the mirror 113.

Reference numeral 120 denotes a movable frame that supports the mirror 110 rotatably around the support shafts 111, 112. The movable frame 120 has an opening 121 for storing the mirror holder 110. In addition, the movable frame 120 has grooves 122, 123 that engage with the support shafts 111, 112 of the mirror holder 110. The movable frame 120 also has at lateral sides support shafts 124, 125 with stoppers at ends thereof, and has a coil 126 attached on a rear side thereof. The coil 126 is wound in a square form.

Reference numeral 130 denotes a fixed frame that supports the movable frame 120 rotatably around the support shafts 124, 125. The fixed frame 130 has a hollow 131 for storing the movable frame 120. In addition, the fixed frame 130 has grooves 132, 133 that engage with the support shafts 124, 125 of the movable frame 120. The fixed frame 130 also has on an inner surface thereof magnets 134 for applying a magnetic field to the coil 114 and magnets 135 for applying a magnetic field to the coil 126. The grooves 132, 133 each extend from the front surface of the fixed frame 130 to a gap between the two vertically-arranged magnets 135.

Reference numeral 140 denotes retainer plates that retain the support shafts 111, 112 of the mirror holder 110 from the front side so as that the shafts do not drop off from the grooves 122, 123 of the movable frame 120. In addition, reference numeral 141 denotes retainer plates that retain the support shafts 124, 125 of the movable frame 120 from the front side so as that the shafts do not drop off from the grooves 132, 133 of the fixed frame 130.

In assembling the mirror actuator 100, the support shafts 111, 112 of the mirror holder 110 are engaged with the grooves 122, 123 of the movable frame 120, and the retainer plate 140 is attached to the front side of the movable frame 120 so as to press the support shafts 111, 112 from the front side. Accordingly, the mirror holder 110 is rotatably supported by the movable frame 120.

After the mirror holder 110 is attached to the movable frame 120 as described above, the support shafts 124, 125 of the movable frame 120 are engaged with the grooves 132, 133 of the fixed frame 130, and the retainer plate 141 is attached to the front side of the fixed frame 130 so as to press the support shafts 132, 133 from the front side. Accordingly, the movable frame 120 is rotatably attached to the fixed frame 130, whereby the mirror actuator 100 is completely assembled.

As the mirror holder 110 rotates around the support shafts 111, 112 with respect to the movable frame 120, the mirror 113 rotates accordingly. In addition, as the movable frame 120 rotates around the support shafts 124, 125 with respect to the fixed frame 130, the mirror holder 110 rotates and the mirror also rotates along with the mirror holder 110. In such a manner, the mirror holder 110 is rotatably supported in a two-dimensional direction by the support shafts 111, 112 and the support shafts 124, 125 which are orthogonal to each other, and the mirror 113 rotates in the two-dimensional direction along with rotation of the mirror holder 110. At the time, the transparent body 200 attached to the support shaft 112 also rotates along with rotation of the mirror 113.

In the assembled arrangement in FIG. 1B, the two magnets are adjusted in layout and polarity by applying a current to the coil 114 such that a rotating force is generated on the mirror holder 110 around the support shafts 111, 112. Therefore, applying a current to the coil 114 generates an electromagnetic drive force on the coil 114 to thereby rotate the mirror holder around the support shafts 111, 112.

In addition, in the assembled arrangement in FIG. 1B, the two magnets 135 are adjusted in layout and polarity by applying a current to the coil 126 such that a rotating force is generated on the movable frame 120 around the support shafts 124, 125. Therefore, applying a current to the coil 126 generates an electromagnetic drive force on the coil 126 to thereby rotate the movable frame 120 around the support shafts 124, 125 and thus rotate transparent body 200 accordingly.

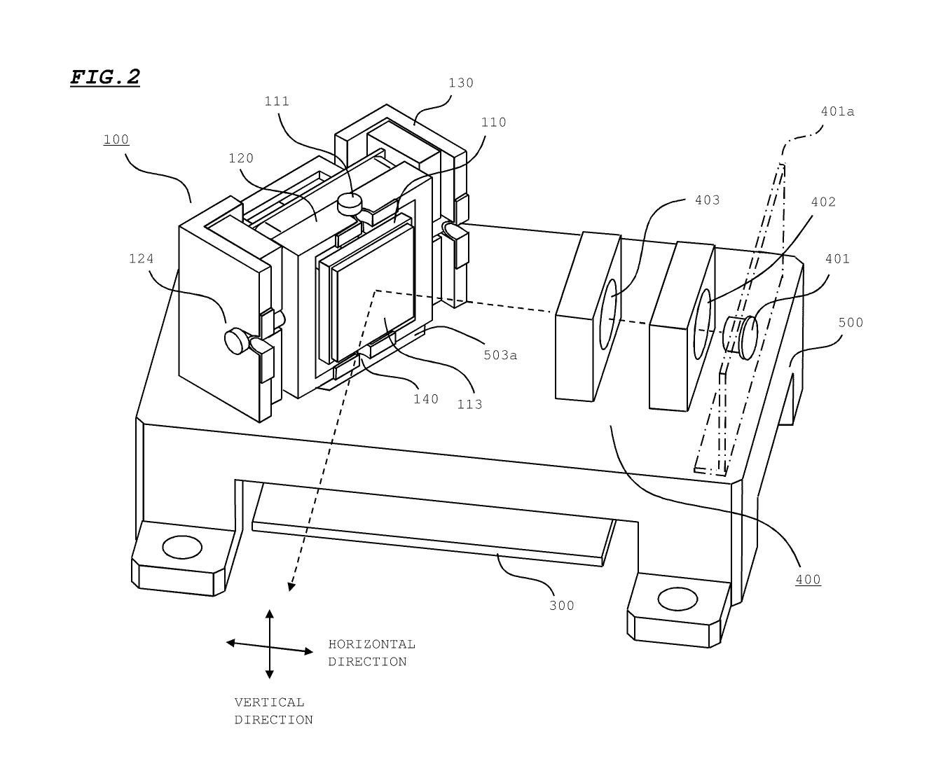

FIG. 2 is a diagram showing a constitution of an optical system with the mirror actuator 100.

In FIG. 2, reference numeral 500 denotes a base for supporting the optical system. The base 500 has an opening 503a for attachment of the mirror actuator 100. The mirror actuator 100 is placed on the base 500 such that the transparent body 200 is inserted into the opening.

The optical system 400 for guiding laser light to the mirror 113 is placed on the base 500. The optical system 400 is formed of a laser light source 401 and beam shaping lenses 402, 403. The laser light source 401 is attached to a laser light source board 401a on the base 500.

Laser light emitted from the laser light source 401 is converged by the lenses 402, 403 in horizontal and vertical directions, respectively. The lenses 402, 403 are designed such that a beam of laser light has predetermined dimensions (e.g. about 2 m long and 1 m wide) in a target region (set at a location of about 100 m forward from a beam launch window of the beam irradiation device, for example).

The lens 402 is a cylindrical lens having a lens effect in the vertical direction, and the lens 403 is an aspherical lens that turns laser light into approximately parallel light. A beam emitted from the laser light source has spread angles varying in the vertical and horizontal directions. The first lens 402 changes proportions of spread angles of laser light in the vertical and horizontal directions. The second lens 403 changes magnification ratios of spread angles of the emitted beam (both in the vertical and horizontal directions).

The laser light having passed through the lenses 402, 403 is entered into the mirror 113 of the mirror actuator 100, and is reflected by the mirror 113 toward a target region. The mirror actuator 100 drives two-dimensionally the mirror 113 to scan the target region with the laser light in the two-dimensional direction.

The mirror actuator 100 is arranged in such a manner, when the mirror 113 is in a neutral position, laser light from the lens 403 is entered into the mirror surface of the mirror 113 at an incident angle of 45 degrees in the horizontal direction. The “neutral position” herein refers to a position of the mirror 113 in which the mirror surface is parallel to the vertical direction and laser light is entered into the mirror surface at an incident angle of 45 degrees in the horizontal direction.

The base 500 has a circuit board 300 on a lower side thereof. In addition, the base 500 also has circuit boards 301, 302 on under and lateral sides thererof.

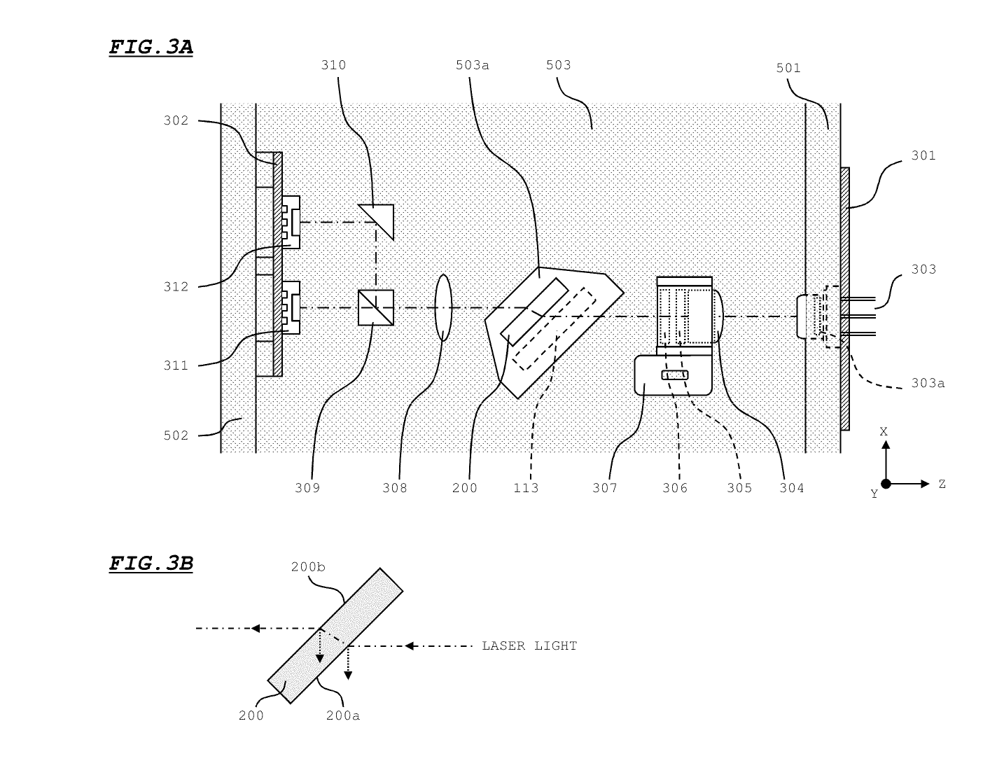

FIG. 3A is a partial plan view of the base 500 as seen from the under side. FIG. 3A shows a portion of the base 500 on the under side in the vicinity of a placement position of the mirror actuator 100.

As shown in the drawing, the base 500 has walls 501, 502 at a peripheral edge on the under side. The base 500 has a flat surface 503 between the walls 501, 502, which is lower than the walls 501, 502. The wall 501 has an opening for attachment of a semiconductor laser 303. The semiconductor laser 303 is inserted into the opening to thereby attach the circuit board 301 with the semiconductor laser 303 to an outer surface of the wall 501. The semiconductor laser 303 has in a package thereof a monitoring PD 303a for monitoring laser light from the semiconductor laser 303. Meanwhile, the base 500 has in the vicinity of the wall 502 the circuit board 302 to which PSDs 311 and 312 for conducting position sensing only in a one-dimensional direction are attached. Hereinafter, such PSDs for conducting position sensing only in the one-dimensional direction will be referred to as “one-dimensional PSDs.”

The base 500 has a collecting lens 304, an aperture 305, a neutral density (ND) filter 306 attached by a fixing tool 307 to a plane surface 503 on the under side. Further, the plane surface 503 has the opening 503a through which the transparent body 200 attached to the mirror actuator 100 projects toward the under side of the base 500. In this arrangement, the transparent body 200 is positioned in such a manner that, when the mirror 113 of the mirror actuator 100 is in the neutral position, two plane surfaces thereof are parallel to the vertical direction and are inclined at an angle of 45 degrees with respect to an axis of light emitted from the semiconductor laser 303.

Laser light from the semiconductor laser 303 (hereinafter, referred to as “servo light”) passes through the collecting lens 304, is decreased in diameter by the aperture 305, and then is attenuated by the ND filter 306. Subsequently, the servo light is entered into the transparent body 200 and is refracted by the transparent body 200.

The servo light having passed through the transparent body 200 is converted to parallel light by a collimator lens 308 and then is guided to a beam splitter 309. The beam splitter 309 reflects the incident servo light and lets the same pass through at a predetermined ratio.

The servo light having passed through the beam splitter 309 is received by the PSD 311 which then outputs a position sensing signal in accordance with a light-receiving position. Meanwhile, the servo light having been reflected by the beam splitter 309 is changed in traveling direction by the mirror 310 and is received by the PSD 312 which then outputs a position sensing signal in accordance with a light-receiving position. By such an action of the optical system, the servo light irradiated onto the PSDs 311, 312 follow almost the same beam tracks.

In this arrangement, the servo light is partly reflected by an incident plane 200a and an output plane 200b of the transparent body 200 (refer to FIG. 3B). An amount of the reflected light varies depending on a rotational position of the transparent body 200. Specifically, when the mirror 113 rotates and the transparent body 200 rotates accordingly at a time of scan of the target region, a reflective ratio and transmission ratio of the transparent body 200 vary depending on an angle thereof, which changes an amount of the servo light reflected by the incident plane 200a and the output plane 200b of the transparent body 200. Therefore, if an emission power of the semiconductor laser 303 is kept constant, amounts of light received at the PSDs 311, 312 are changed by rotation of the transparent body 200, which results in an error between position sensing signals from the PSDs 311, 312.

For control of such an error, the transparent body 200 has means for suppressing interface reflection, such as an antireflection film, on a surface thereof. This reduces proportions of servo light reflected on the incident plane and output plane of the transparent body 200, thereby to decrease variations in amounts of servo light received at the PSDs 311, 312. Consequently, it is possible to prevent an error between position sensing signals.

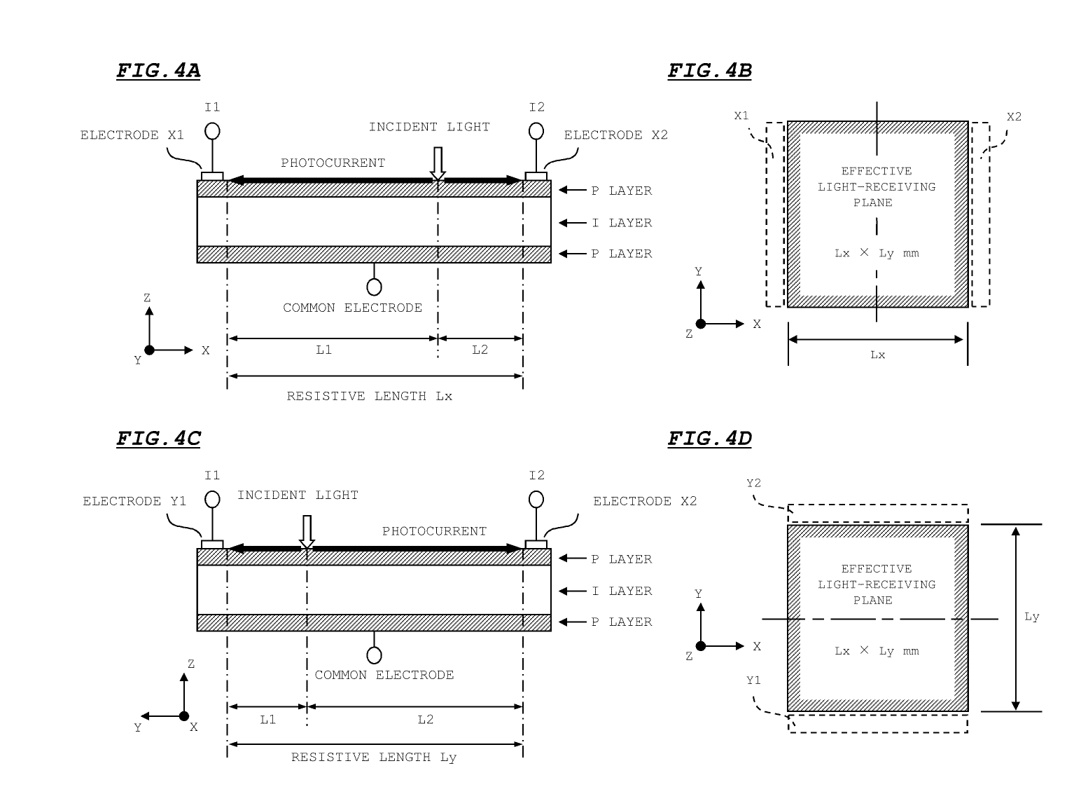

FIGS. 4A and 4C are sectional side views of the PSDs 311, 312, respectively. FIGS. 4B and 4D are diagrams showing light-receiving planes of the PSDs 311, 312, respectively.

As illustrated in FIG. 4A, the PSD 311 has a P-type resistive layer acting both as a light-receiving plane and a resistive layer on an N-type high-resistance silicon substrate. The resistive layer has electrodes X1, X2 on a front side for outputting a photocurrent in a horizontal (X-axis) direction of FIG. 4B, and has a common electrode on an under side. As shown in FIG. 4C, the PSD 312 has the same structure as that of the PSD 311, except for layout of the electrodes. Specifically, the PSD 312 has electrodes Y1, Y2 for outputting a photocurrent in a vertical (Y-axis) direction of FIG. 4D.

In the effective light-receiving planes of the PSD 311, 312, the horizontal (X-axis) width is designated as Lx, and the vertical (Y-axis) width as Ly for illustrative purposes. However, the dimensions of the light-receiving planes are not limited to the foregoing ones. The light-receiving planes may be of any other sizes as far as such sizes cover a track of scan with servo light in accordance with a rotational range of the transparent body 200.

Next, a method for determining position sensing at the PSDs 311, 312 will be described below. When laser light is irradiated onto the light-receiving plane of the PSD, an electric charge is generated at an irradiation position in proportion to a light amount. The electric charge as a photocurrent reaches the resistive layer, and is split in inverse proportion to distances to the electrodes. The split photocurrents are output from the electrodes X1, X2 for the PSD 311, and are output from the electrodes Y1, Y2 for the PSD 312.

In this arrangement, the currents output from the electrodes X1, X2 of the PSD 311 have magnitudes split in inverse proportion to the distances from the laser light irradiation position to the electrodes. Accordingly, it is possible to detect a light irradiation position in the X-axis direction on the light-receiving plane, based on current values output from the electrodes X1, X2.

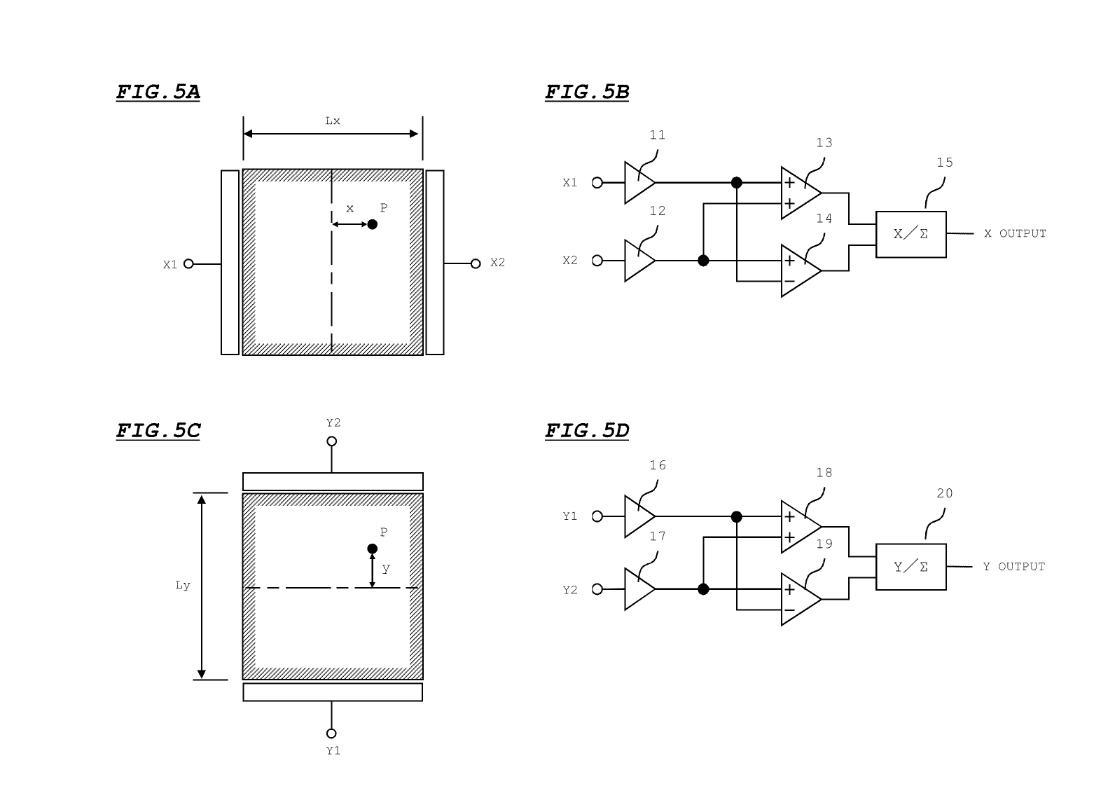

For example, servo light is irradiated onto the PSD 311 at a position P shown in FIG. 5A. In this case, assuming that currents output from the electrodes X1, X2 are designated as Ix1, Ix2, respectively, and that a distance between the electrodes in the X direction is designated as Lx, an X coordinate x of the position P with a center in the light-receiving plane as a reference point can be calculated by the following equation:

$$\frac{Ix 2 - Ix 1}{Ix 2 + Ix 1} = \frac{2 x}{Lx} \qquad ( 1 )$$

Similarly, if servo light is irradiated onto the PSD 312 at a position P shown in FIG. 5C, assuming that currents output from the electrodes Y1, Y2 are designated as Iy1, Iy2, respectively, and that a distance between the electrodes in the Y direction is designated as Ly, a Y coordinate y of the position P can be calculated by the following equation:

$$\frac{Iy 2 - Iy 1}{Iy 2 + Iy 1} = \frac{2 y}{Ly} \qquad ( 2 )$$

FIGS. 5B and 5D are diagrams showing constitutions of arithmetic circuits realizing the foregoing equations (1) and (2).

In FIGS. 5B and 5D, the current signals Ix1, Ix2, Iy1, and Iy2 output from the electrodes X1, X2, Y1, and Y2, are amplified and converted into voltages by I/V amplifiers 11, 12, 16, and 17. In addition, adding circuits 13 and 18 perform calculations of the foregoing equations (Ix2+Ix), and (Iy2+Iy1), respectively. Further, subtracting circuits 14 and 19 perform calculations of the foregoing equations (Ix2−Ix1), and (Iy2−Iy1), respectively. Moreover, dividing circuits 15 and 20 perform divisions on the left sides of the foregoing equations (1) and (2), respectively, and those circuits output position sensing signals indicative of an X-direction position (2x/Lx) and a Y-direction position (2y/Ly) at the servo light-receiving position P.

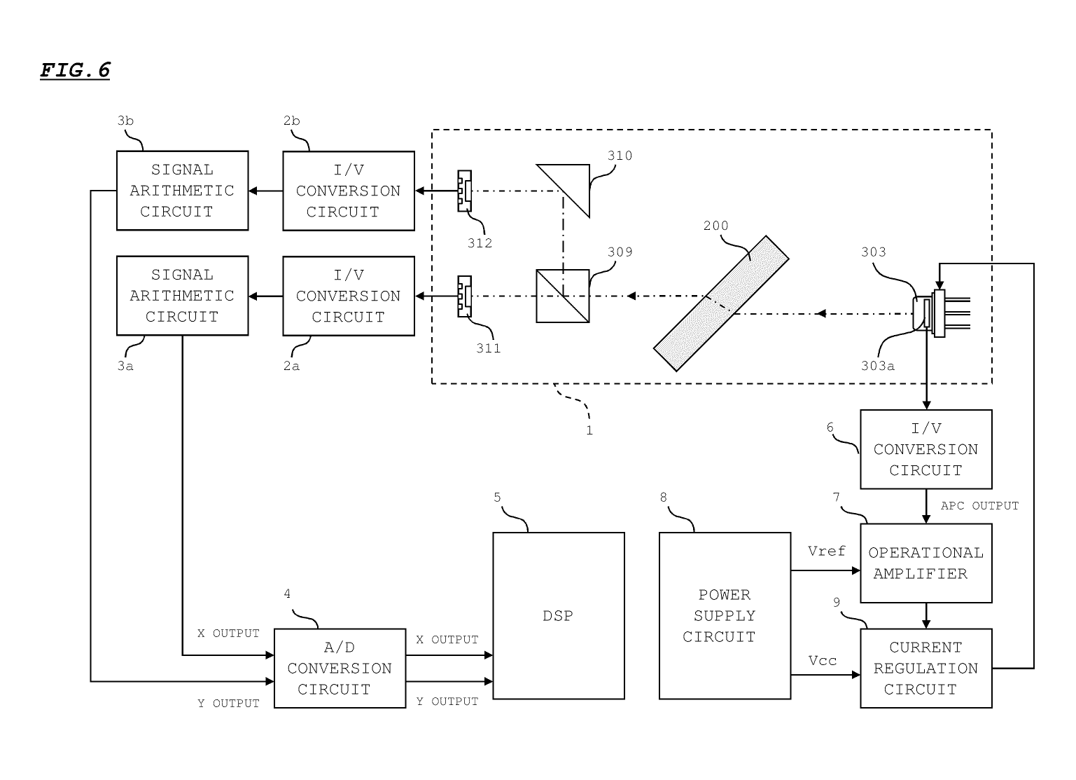

FIG. 6 is a diagram showing a constitution of a position sensing circuit for the PSDs 311, 312. The position sensing circuit includes I/V conversion circuits 2a and 2b, signal arithmetic circuits 3a and 3b, an A/D conversion circuit 4, and a digital signal processor (DSP) 5. FIG. 6 shows circuits for adjusting an amount of light emitted from the semiconductor laser 303 (an I/V conversion circuit 6, an operational amplifier 7, a power supply circuit 8, and a current regulation circuit 9) for illustrative purposes. Reference numeral 1 denotes the servo optical system in FIG. 3 and only main components thereof are illustrated in FIG. 6.

The I/V conversion circuit 2a corresponds to the I/V amplifiers 11, 12 shown in FIG. 5B, and the I/V conversion circuit 2b corresponds to the I/V amplifiers 16 and 17 shown in FIG. 5D. The signal arithmetic circuit 3a corresponds to the adding circuit 13, the subtracting circuit 14, and the dividing circuit 15 shown in FIG. 5B. The signal arithmetic circuit 3b corresponds to the adding circuit 18, the subtracting circuit 19, and the dividing circuit 20 shown in FIG. 5D.

An X output from the signal arithmetic circuit 3a and a Y output from the signal arithmetic circuit 3b, are converted into digital signals by the A/D conversion circuit 4, and then are input into the DSP 5. The DSP 5 detects a laser light scan position in the target region on the basis of the X output and Y output, and controls drive of over the mirror actuator 100 and the laser light source 401.

Meanwhile, an output from the monitor PD 303a is converted by the I/V conversion circuit 6 into a voltage signal, and is input as a power adjustment output (APC output) into the operational amplifier 7.

The operational amplifier 7 compares a reference voltage Vref of specific level to be input from the power supply circuit 8 with the APC output, and then outputs a control signal to the current regulation circuit 9 in accordance with a comparison result. In this arrangement, the operational amplifier 7 increases a control signal until the APC output reaches the reference voltage Vref, and lowers the control signal if the APC output exceeds the reference voltage Vref. The current regulation circuit 9 includes a resistor and a transistor, and outputs a drive signal of a magnitude that is proportional to the control signal from the operational amplifier 7. The drive signal output from the current regulation circuit 9 is supplied to the semiconductor laser 303.

If an output from the monitor PD 303a decreases due to deterioration or the like of the semiconductor laser 303, the APC output to the operational amplifier 7 becomes smaller than the reference voltage Vref, and the control signal output from the operational amplifier 7 increases as stated above. Accordingly, a drive current supplied from the current regulation circuit 9 to the semiconductor laser 303 increases with an increase in servo light emission power.

By such a servo operation, an emission power of the semiconductor laser 303 is controlled such that the APC output coincides with the reference voltage Vref, whereby the servo light emission power can be kept approximately constant. Consequently, it is possible to keep an amount of light received at the PSD approximately constant and prevent an error in position sensing.

Meanwhile, since a saturation current value of a one-dimensional PSD is larger than that of a two-dimensional PSD, an amount of light received at the one-dimensional PSD allowing proper position sensing becomes larger than that of the two-dimensional PSD. Accordingly, using the one-dimensional PSD enhances a servo light emission power as compared with using the two-dimensional PSD. As a result, it is possible to reduce influence of ambient light on an output current and to increase an accuracy of position sensing at the PSD.

In addition, there is currently provided an extended lineup of one-dimensional PSDs, which makes it possible to select appropriate PSDs allowing proper position sensing while allowing the device to remain compact.

As stated above, according to the embodiment of the present invention, the two one-dimensional PSDs 311, 312 are used to detect individually the incident positions of servo light in the X-axis direction and the Y-axis direction. This makes it possible to obtain proper position sensing signals as compared with using one two-dimensional PSD. Accordingly, it is possible to detect a laser light scan position in the target region with excellent accuracy.

### MODIFICATION EXAMPLE 1

An example of an arrangement using a diffraction grating as spectral means will be described below. The same components in this arrangement as those in the above embodiment are not illustrated or described for sake of simplicity.

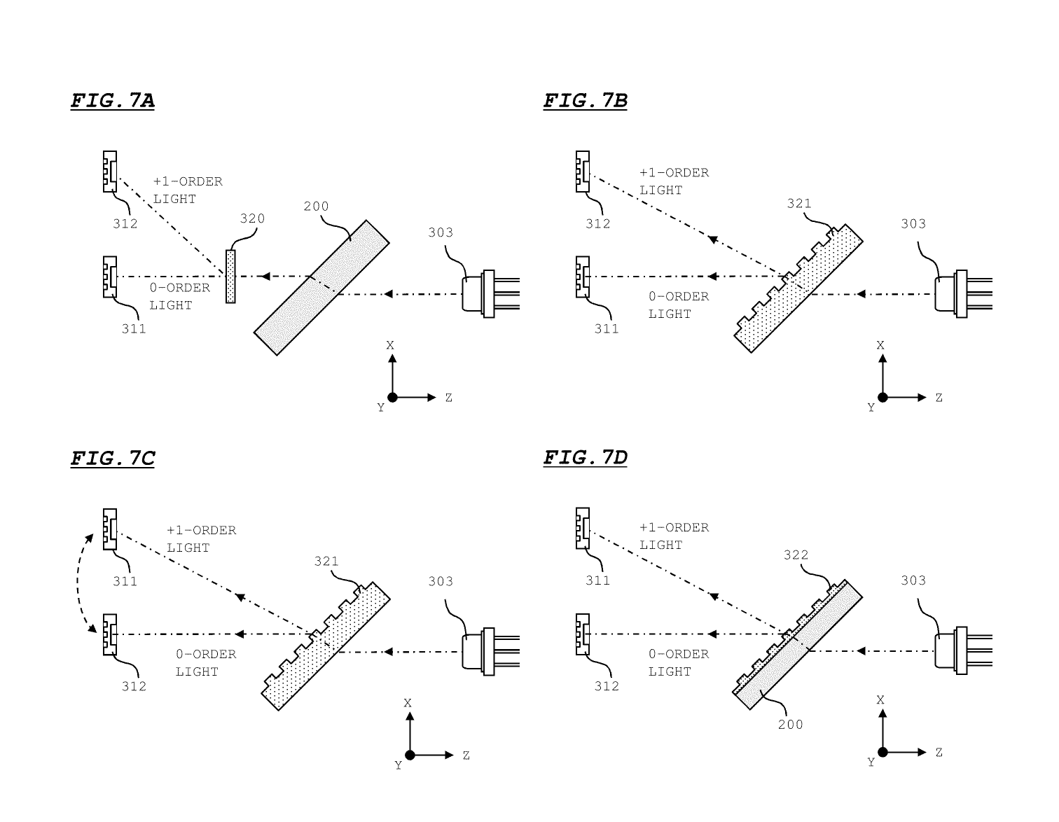

FIG. 7A shows an example of an arrangement in which a hologram element 320 is used in place of the beam splitter 309 and the mirror 310 shown in FIG. 3A. The hologram element 320 has a diffraction pattern in which servo light is diffracted in an in-plane direction on an X-Z plane shown in FIG. 7A.

As illustrated, the servo light having entered the hologram element 320 is split into 0-order light and +1-order light by a diffraction action of the hologram element 320, and the split lights are received at the PSDs 311, 312. In this arrangement, the PSDs 311, 312 are each formed of a one-dimensional PSD as stated above.

With such an arrangement shown in FIG. 7A, it is possible to receive servo light at the one-dimensional PSDs, thereby producing the same advantageous effects as those in the foregoing embodiment. Further, since the servo element 320 is used to split servo light, it is possible to reduce parts count and simplify the device structure as compared with the foregoing embodiment.

FIG. 7B shows an example of an arrangement in which the hologram element 321 having almost the same thickness as that of the transparent body 200 is used in place of the transparent body 200, the beam splitter 309, and the mirror 310 shown in FIG. 3A. The hologram element 321 has on a servo light output plane a diffraction pattern in which servo light is diffracted in an in-plane direction on an X-Z plane shown in FIG. 7B.

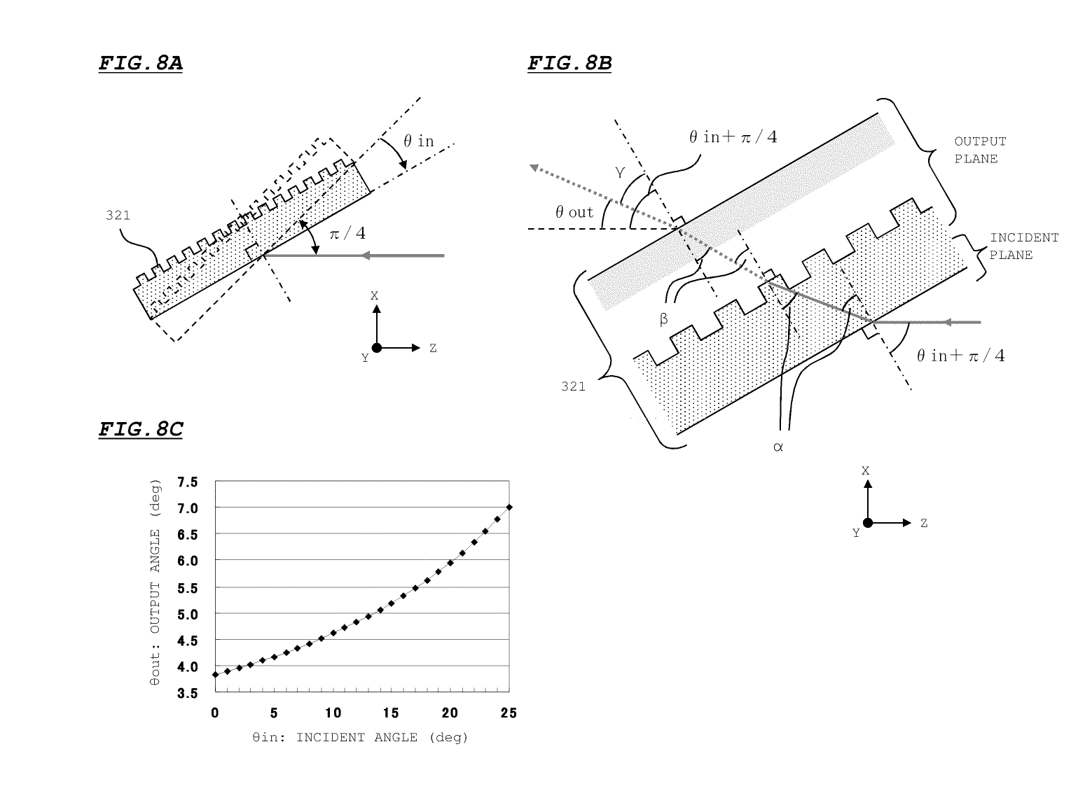

FIGS. 8A to 8C are diagrams showing that servo light is refracted and diffracted by the hologram element 321 in the arrangement shown in FIG. 7B. As shown in FIG. 8A, a rotational angle θin of the hologram element 321 is set with reference to the hologram 321 in a neutral position (shown by a dotted line in FIG. 8A).

FIG. 8B is a diagram showing a principle that a servo light is refracted on the incident plane of the hologram element 321, and is diffracted and refracted on the output plane of the same.

The servo light having entered the hologram element 321 is refracted on the incident plane in a direction of α with respect to the normal of the incident plane. In this arrangement, assuming that a refraction index of the hologram element is designated as n, sin α can be obtained by the following operation:

sin α=(sin(θin+π/4))/n (3)

In addition, the servo light is first split into 0-order light and +1-order light on the output plane of the hologram element 321. In FIG. 8B, only a path of the +1-dimensional light is shown by a dotted line for sake of simplicity.

The 0-order light is not diffracted but refracted on the output plane. As a result, the direction of output from the hologram element 321 and the direction of entrance into the hologram element 321 become parallel to each other.

The +1-order light is first diffracted and changed in traveling direction, and further is refracted. In this arrangement, assuming that the +1-order light is diffracted in a direction of β with respect to the normal of the output plane and that a wavelength of the servo light is designated as λ and a pitch in a diffraction pattern of the hologram element 321 as P, sin β can be obtained by the following operation:

sin β=sin α−λ/P (4)

In addition, assuming that the +1-order light is diffracted in a direction of γ of the normal to the output plane, sin γ can be obtained by the following operation:

sin γ=n sin β (5)

By the foregoing equations (3) to (5), sin γ can be expressed by the following equation using θin:

sin γ=n((sin(θin+π/4))/n−π/P)

Accordingly, an angle θout formed by the 0-order light and +1-order light can be obtained by the following operation:

$$\begin{matrix}θ out = θ in + π / 4 - γ \\ = θ in + π / 4 - arc sin ( n ( ( sin ( θ in + π / 4 ) ) / n - λ / P ) )\end{matrix}$$

Herein, the foregoing operational expression is used to determine the output angle θout with a change in the incident angle θin, under the following simulation conditions:

(1) Refraction index (n) of the hologram element 321: 1.5

(2) Wavelength (λ) of servo light: 0.65 (μm)

(3) Pitch in a diffraction pattern of the hologram element 321: 20 (μm)

FIG. 8C is a graph showing results of the foregoing simulation. Referring to the graph, the values of θin and θout correspond to each other on a one-to-one basis. Therefore, it is possible to detect a rotational position of the hologram element 321 around the Y axis by the PSD 311 conducting position sensing in the X-axis direction.

As understood with reference to the graph, since the value of θout becomes larger with increase in the value of θin, a beam track on the PSD receiving the +1-order light is extended in the X-axis direction beyond a beam track on the PSD receiving the 0-order light. Therefore, by conducting position sensing in the horizontal (X-axis) direction on the PSD receiving the +1-order light, it is possible to enhance a resolving power in position sensing and obtain a position sensing signal with higher accuracy.

Therefore, if the hologram element 321 is used in place of the transparent body 200, it is preferred to interchange the PSD 311 and PSD 312 and use a one-dimensional PSD as the PSD 311 that covers a beam track of +1-order light and has a light-receiving plane wider in the X-axis direction, as shown in FIG. 7C.

As stated above, in the arrangement shown in FIG. 7B or 7C, a rotational position of the hologram element 321 rotating along with the mirror 113 can be detected by the one-dimensional PSDs 311, 312, thereby producing the same advantageous effects as those in the foregoing embodiment. In addition, by using the hologram element 321 in place of the transparent body 200, the beam splitter 309, and the mirror 310, it is possible to reduce parts count and simplify the device structure as compared with the foregoing embodiment.

Although the arrangements shown in FIGS. 7B and 7C each use the hologram element 321 with a diffraction pattern formed on the output plane, the hologram element 322 may be integrated into the output plane of the transparent body 200 instead, as shown in FIG. 7D, for example. The hologram element 322 has a diffraction pattern in which a servo light is diffracted in an in-plane direction on an X-Z plane shown in FIG. 7D.

In this arrangement, servo light is refracted on an interface between the transparent body 200 and the hologram element 322, and then is subjected in the diffraction pattern of the hologram element 322 to the same action as on the output plane of the hologram element 321 shown in FIGS. 7B and 7C. Therefore, as in the arrangements shown in FIGS. 7B and 7C, this arrangement extends a beam track on the PSD receiving +1-order light in the X-axis direction beyond a beam track on the PSD receiving 0-order light. Accordingly, it is also preferred in the arrangement shown in FIG. 7D that the PSD 311 receives +1-order light and uses a one-dimensional PSD in which the light-receiving plane is wider in the X-axis direction.

Besides, although a diffraction pattern is provided on the output plane of the hologram element 321 in the arrangements shown in FIGS. 7B and 7C, the diffraction pattern may be provided on the incident plane of the same. In addition, although the hologram element 322 is integrated into the output plane of the transparent body 200 in the arrangement shown in FIG. 7D, the hologram element 322 may be integrated into the incident plane of the same.

In each of the foregoing arrangements, if the hologram element has a step-type diffraction pattern, a diffraction efficiency and diffraction angle of the hologram element are determined by a step height and a pitch in the diffraction pattern, respectively. If the hologram element has a blaze-type diffraction pattern, a diffraction efficiency and diffraction angle of the hologram element are determined by a blaze height and a pitch in the diffraction pattern, respectively. Accordingly, if servo light is guided to the PSDs 311, 312 by a diffraction action, it is necessary to set layouts of a diffraction pattern and an optical system in advance so that the PSDs 311, 312 receive properly 0-order light and +1-order light.

As stated above, in the arrangements of this modification example, servo light can be received at the one-dimensional PSDs 311, 312. Accordingly, it is possible to obtain precise position sensing signals as compared with using one two-dimensional PSD, thereby to detect a laser light scan position in the target region with excellent accuracy.

### MODIFICATION EXAMPLE 2

Although the transparent body 200 is used to change a traveling direction of servo light along with rotation of the mirror actuator 100 in the foregoing embodiment and modification example, the same advantageous effects can also be obtained by providing a servo light source at an end of the mirror actuator. This modification example will be described below with reference to the drawing.

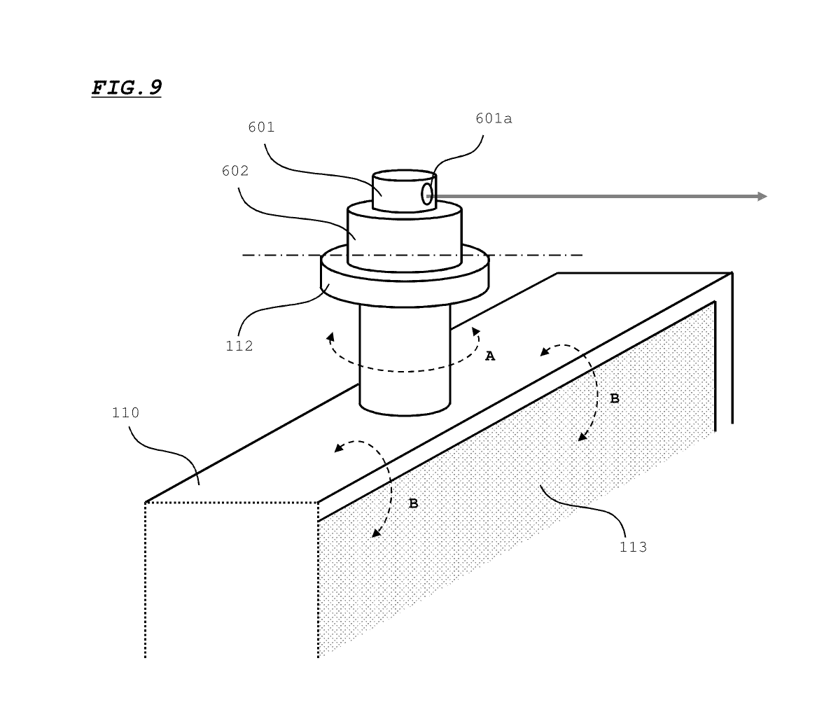

FIG. 9 is a diagram of a modified constitution of the support shaft 112 shown in FIG. 1A. A laser chip 601 and a heat sink 602 are attached to an end of the support shaft 112, in place of the transparent body 200 and the receiver 112a. The laser chip 601 is attached to the end of the support shaft 112 with the heat sink 602 therebetween, and has a light-emitting portion 601a.

In this arrangement, the laser element 601 is attached to the end of the support shaft 112 such that the light-emitting portion 601a is positioned on a center of the support shaft 112 and a laser light output direction is perpendicular to a central axis of the support shaft 112. Therefore, even when the support shaft 112 rotates, the light-emitting portion 601a of the laser chip 601 is not displaced but is simply turned around the shaft center.

When the mirror actuator 100 is attached to the base 300 as shown in FIG. 3A, the laser chip 601 projects from the opening 503a to the under side of the base 300. In this arrangement, servo light emitted from the laser chip 601 is also split into two beams by the collimator lens 308, the beam splitter 309, and the mirror 310, and then the beams are received by the PSDs 311, 312, respectively.

As stated above, in the arrangement of this modification example, servo light can also be received by the one-dimensional PSDs 311, 312. Accordingly, it is possible to obtain precise position sensing signals as compared with the case of using one two-dimensional PSD, thereby to detect a laser light scan position in the target region with excellent accuracy.

With regard to the descriptions on the foregoing embodiment and modification examples of the present invention, the present invention is not limited to those embodiment and modification examples. In addition, the embodiment of the present invention may be modified in various manners besides those described below.

For example, although a semiconductor laser is used as a servo light source in the embodiment and modification examples, a light emitting diode (LED) may be used instead.

In addition, layouts of the PSDs 311, 312 may be reversed from those in the embodiment and the modification examples. However, in the arrangements shown in FIGS. 7C and 7D, a range of a beam track of +1-order light is extended in the X-axis direction, and it is therefore preferred that the PSD 311 for the X-axis direction receives +1-order light.

Although the target region is scanned with laser light by driving the mirror 113 in the embodiment and the modification examples, the target region may be scanned with laser light by driving a lens two-dimensionally in place of the mirror 113. In this case, for example, part of the laser light having passed through the lens is branched by the beam splitter so that the branched laser light is received as servo light by the PSDs. Similarly in this arrangement, the servo light is further branched into two beams, and the two laser beams are received by the PSD for the X-axis direction and the PSD for the Y-axis direction, respectively.

In addition, although in the embodiment and the modification example 1, the transparent body is used to change a traveling direction of servo light, a servo mirror may be attached to the support shaft 112 of the mirror actuator 100 in place of the transparent body, thereby to reflect servo light and change a traveling direction of the same.

The optical system for position sensing described in relation to the embodiment and the modification examples can be applied to various devices other than the beam irradiation device mounted on a laser radar. For example, the optical system may be used in an automatic-tracking astronomical observation device. In this example, the transparent body is attached to a lens tube such that a traveling direction of servo light is changed with movement of the lens tube, for instance. In addition, the servo light having passed through the transparent body is branched into two beams by a diffraction grating or the like, and the two beams are received by two PSDs, respectively. This arrangement enhances a detection accuracy of a lens tube position or an astronomic observation position, as in the cases with the embodiment and the modification examples.

In addition, the embodiment of the present invention can be appropriately modified in various manners within the scope of a technical idea defined by the claims.

What is claimed is:

1. A beam irradiation device, comprising:
an actuator scanning a target region with laser light in a two-dimensional direction; and
a servo optical system changing a traveling direction of servo light along with driving of the actuator, wherein
the servo optical system includes:
a splitting element splitting the servo light;
a first position sensing device receiving a first beam split by the splitting element and outputting a signal in accordance with a light-receiving position in a first direction; and
a second position sensing device receiving a second beam split by the splitting element and outputting a signal in accordance with a light-receiving position in a second direction different from the first direction.

2. The beam irradiation device according to claim 1, wherein
the first direction and the second direction are orthogonal to each other.

3. The beam irradiation device according to claim 1, wherein
the splitting element is a beam splitter.

4. The beam irradiation device according to claim 1, wherein
the splitting element is a diffraction grating.

5. The beam irradiation device according to claim 1, wherein
the actuator has:
a mirror changing a traveling direction of the laser light;
a first supporting part supporting the mirror rotatably in a first rotational direction;
a second supporting part supporting the first supporting part rotatably in a second rotational direction different from the first rotational direction; and
an electromagnetic driving part driving the first supporting part and the second supporting part in the first rotational direction and the second rotational direction.

6. The beam irradiation device according to claim 5, wherein
the servo optical system includes an optical element into which servo light is entered and which rotates along with rotation of the actuator.

7. The beam irradiation device according to claim 6, wherein
the optical element is a flat-plate transmissive member.

8. The beam irradiation device according to claim 6, wherein
the optical element is attached to a rotational axis of the first supporting part.

9. The beam irradiation device according to claim 5, wherein
a servo light source emitting the servo light is arranged in the actuator, and a traveling direction of the servo light is changed along with rotation of the mirror.

10. A position sensing device changing a traveling direction of servo light along with movement of a movable part, thereby to detect a movement position of the movable part, comprising:
a splitting element splitting the servo light;
a first position sensing device receiving a first beam split by the splitting element and outputting a signal in accordance with a light-receiving position in a first direction; and
a second position sensing device receiving a second beam split by the splitting element and outputting a signal in accordance with a light-receiving position in a second direction different from the first direction.
